(19) United States
(12) Patent Application Publication
(10) Pub. No.: US 2009/0094060 A1
(43) Pub. Date: Apr. 9, 2009

(54) METHOD AND SYSTEM FOR CONSUMER HEALTHCARE DECISIONMAKING

(75) Inventors: Ann Mond JOHNSON, River Forest, IL (US); Tracy J. HEILMAN, Chicago, IL (US); Joseph DONLAN, Chicago, IL (US); John FIACCO, Alpharetta, GA (US)

Correspondence Address: WILMERHALE/BOSTON, 60 STATE STREET, BOSTON, MA, 02109, US

(73) Assignee: WEBMD, New York, NY (US)

(21) Appl. No.: 12/200,465

(22) Filed: Aug. 28, 2008

Related U.S. Application Data
(63) Continuation of application No. 09/945,038, filed on Aug. 31, 2001, now abandoned.

(51) Int. Cl. G06F 17/30; G06Q 50/00

(52) U.S. Cl. 705/3

(57) ABSTRACT

A method and system for healthcare decisionmaking wherein a consumer begins with a diagnosis, is educated on the interpretation of relevant data relating thereto, assess risk, selects and prioritizes search criteria, reviews treatment option results and compares the results based on their preference, or by using statistically valid data derived from consumers like themselves. The method and system presents a structured framework for communicating information that has been personalized and customized to an individual who is a consumer of information about healthcare. The system is a networked, knowledge-based system that assists the consumer in assessing healthcare treatment options for a variety of healthcare conditions, procedures and clinical diagnoses. The system includes a server and a server-driven remote interface through which a series of progressively more personalized presentations of information are achieved by matching a consumer's preferences with those of demographically similar consumers and best practice information obtained from a variety of public and private sources.

This application is a continuation of U.S. patent application Ser. No. 09/945,038, filed on Aug. 31, 2001.

The present invention relates generally to healthcare decisionmaking, and in particular, to a method and system for consumer healthcare decisionmaking. Specifically, the present invention comprises a method and system which allow a consumer who is not a health care professional, to evaluate, compare and select treatment options for a previously diagnosed healthcare condition or prescribed procedure.

### BACKGROUND OF THE INVENTION

Consumers who are not healthcare experts, when confronted with a medical diagnosis or a recommendation for a particular type of healthcare treatment, have few means of making an informed decision. Unlike, for example, the financial services industry, few tools exist which allow an individual consumer, without the active assistance of a domain expert, to make an evidence-based comparison of the data associated with different healthcare options and then analyze them in terms of personal predilections for risk, quality, quantity, rigor or other factors. For the most part, consumers consult with family and friends, ask for health care benefit guidance from representatives of their employers, labor union or healthcare insurance providers, consult anecdotal evidence available in books and magazines, occasionally ask for a second opinion from another healthcare provider and increasingly attempt to search for relevant information on the Internet and the World Wide Web. Indeed, consumer surveys have led to the estimate that over 80% of consumers accessing information on the Internet are in fact searching for healthcare information.

Until recently, consumer choices were so limited by, among other factors, geographic constraints, health care maintenance organization restrictions and the unavailability of objective information about either healthcare provider performance or consumer satisfaction, that creating a tool to assist consumers through the decision making process was a practical impossibility. As a consequence, decision support products in the healthcare area have been focused on the needs of healthcare delivery professionals to automate the diagnostic process or of health care delivery system and underwriting professionals to understand the cost/benefit relationship of various treatment options. Consumer focus, when present, has consisted of schemes to use various communication technologies (telephone, videoconferencing, remote sensing) to reduce the cost of the relationship between healthcare provider personnel (nurses, physicians, etc) and their patients. However, recent changes in the practice of healthcare and benefits management, particularly the emergence of defined contribution benefit plans, combined with increased availability and access to healthcare performance data have converged to make the creation of such tools both feasible and useful to consumers faced with new choices.

Decision support systems in the health care domain have tended to fall into two groups:

First are expert systems that assist a clinical domain expert in the marshalling of facts (symptoms, patient history, diagnostic tests, etc.) to support a differential diagnosis. The most well-known example of this approach is MYCIN, an artificial intelligence project at Stanford Medical School from 1972-1980, which supported the diagnosis of bacterial infections. Similar projects using related techniques have been developed for other disease entities, to support clinical practitioner training and to provide guidance in the gathering of data for clinical outcomes studies. A common characteristic of all these systems is the necessity that the user must have mastery of a sophisticated medical lexicon, detailed knowledge of anatomy, physiology, biological and biochemical processes and some familiarity with pharmacological and diagnostic tools relevant to the problem domain before meaningful use of the system is possible. Within the knowledge constraints placed upon the operator, such systems have proven to be highly accurate.

Expert systems have also served as a component of the Dial-A-Nurse and Dial-A-Practitioner programs that have been implemented by several health maintenance organizations in the United States. Using these systems, an expert practitioner takes the consumer through a directed series of questions to establish a probable diagnosis and treatment recommendation.

With the advent of the Internet and the World Wide Web, several attempts have been made to provide an equivalent “consumer diagnostic tool” by pairing a medical dictionary and encyclopedia, often restricted to a specific disease domain, with some type of search engine or decision tree. Of the reported 16,000 medical and healthcare sites on the Internet in 1999, most were devoted to this type of approach. Such approaches lack the sophisticated deductive logic and inference engines characteristic of tools such as MYCIN and instead operate through simple keyword matching and relevance ranking. In the absence of constraints on the lexicon, there is no way to assure that matches between reported symptoms and symptom descriptions actually have a common referent. Therefore, the validity of such tools is dubious.

Second, both insurance companies and organizations studying epidemiology, for instance the Center for Disease Control, have developed software simulation systems to model the impact of treatment options, including the availability of new diagnostic procedures, the availability of new drugs and access to primary care, on various populations. These systems have been used largely to advise government entities (state insurance commissions, legislative budget boards, Medicare and Medicaid) on the economic and public health impact of various policy decisions. Like expert systems for diagnosis, usefulness assumes a team of skilled practitioners with expertise not only in the particular healthcare domain under consideration but also in the statistical and demographic domains relevant to simulation and modeling.

The shortcomings of these approaches are:
a) Tools have been focused on diagnosis, the proper domain of clinical professionals. Consumers need information to determine how to obtain the best treatment.
b) Current tools can only be used reliably by healthcare experts.
c) Results can only be interpreted reliably by healthcare experts.
d) Could constitute illegal practice of medicine when offered for use by an untrained consumer.
e) Likely to lead to both false positive diagnosis, unnecessary treatment.
f) Equally likely to lead to false negative diagnosis, incorrect or inadequate treatment.
g) Provide consumer only with description of treatment options under assumption of correct diagnosis, but no means of evaluating treatment options relative to the consumer's personal situation or assessing current norms for treatment.

The present invention, however, overcomes the problems and disadvantages of these known approaches to healthcare decisionmaking.

### BRIEF SUMMARY OF THE INVENTION

The present invention comprises a method and system for consumer healthcare decisionmaking. In accordance with the present invention, the consumer presents a diagnosis or recommendation for treatment that has previously been obtained from a qualified healthcare professional. The consumer is then guided through a framework using criteria derived from demographically similar consumers and obtains from one or more databases a set of healthcare options that are a fit to the consumer's own criteria for evaluating treatment options. This allows the consumer to compare each option with regard to the best performance, outcomes, cost and risk information available.

The present invention further comprises a system which provides information about healthcare treatments, procedures and condition that has a higher probability of meeting the consumer's needs because it is based on experience with similar consumers in making similar requests in the same domain. The system remotely interacts with an individual, where both the queries and alternatives presented are dynamically presented on the basis of the best-available, statistically-validated outcomes data, disease management protocols, and risk data derived from physician, hospital and clinic profiles, Federal (Medicare), state (Medicaid) and private insurance company claims data, and the individual's expressed demographic, geographic and personal preferences insofar as they are relevant to the healthcare treatment that has been previously recommended to the individual, the diagnosis which the individual has received, or the chronic condition for which the individual seeks information.

Accordingly, besides the advantages mentioned above, several objects and advantages of the present invention are:
a) To provide a means whereby a consumer can assess the financial impact of various treatment options.
b) To provide a means whereby a consumer can assess the performance of healthcare providers relative to other healthcare providers when providing services related to a similar diagnosis, condition or treatment.
c) To provide a means whereby a consumer can establish and prioritized criteria that are personally important in the selection of a provider of healthcare services.
d) To provide a user decisionmaking framework which progresses from identification and selection of the problem under consideration, to education and identification of variable elements related to the problems, selection and ranking of criteria and detailed comparison of results.
e) To provide a means to adaptively evolve the system's criteria based on the preferences and rankings of a user community.
f) To provide a means for allowing the consumer to enter demographic information which may be relevant to the problem under consideration.
g) To provide a means for enabling a consumer to access medical information related to the problem under consideration.
h) To provide a means to retrieve information from multiple healthcare databases to obtain treatment options results which are the best fit to consumer criteria and ranking.
i) To provide a database which stores past consumer criteria related to healthcare choices, and a means of querying the database to correlate an individuals demographic characteristics (age, sex, education, region, etc) with preferences contained in the database.
j) To provide a means of adding a consumers preference criteria and demographic data to the database.
k) To provide a database for storing health care provider information, including location, capabilities, procedures performed and conditions treated per annum.
l) To provide a database for storing consumer healthcare preference information that has been obtained by external agencies, public opinion surveys and previous users of the system.
m) To provide a method which guides a non-expert consumer through a system for healthcare decisionmaking, specifically for the selection of treatment options for a previously diagnosed condition or prescribed procedure, and which utilizes a packet-based communication network, the Internet and/or the World Wide Web to deliver the results to a remote consumer communication device, and/or to a remote server device for reformatting or enhancing of the results before presentation to a consumer.

Numerous other advantages and features of the invention will become readily apparent from the detailed description of the preferred embodiment of the present invention, from the claims and from the accompanying drawings in which like numerals are employed to designate like parts throughout the same.

### BRIEF DESCRIPTION OF THE DRAWINGS

A fuller understanding of the foregoing may be had by reference to the accompanying drawings wherein:

FIG. 1 is a block diagram of the present invention.

FIG. 2 is a main flowchart of the present invention.

FIG. 3 is a flowchart of the Educate Consumer step of the present invention.

FIG. 4 is a flowchart of the Select Provider Facility step of the present invention.

FIG. 5 is a flowchart of the Personal Selection Criteria of the present invention.

FIG. 6 is an Initial Diagnosis Decision Selection screen of the present invention.

FIG. 7 is a Demographic Collection screen of the present invention.

FIG. 8 is a Consumer Education Characteristics screen of the present invention.

FIG. 9 is a Consumer Education Risk and Recovery screen of the present invention.

FIG. 10 is a Rank Criteria screen of the present invention.

FIG. 11 is a Best Fit Responses to Query screen of the present invention.

FIG. 12 is a Compare by Personally Important Criteria screen of the present invention.

FIG. 13 is a block diagram of an alternate embodiment of the present invention.

FIG. 14 is a block diagram of another alternate embodiment of the present invention.

### DETAILED DESCRIPTION

While the invention is susceptible of embodiment in many different forms, there is shown in the drawings and will be described herein in detail a preferred and alternate embodiments of the present invention. It should be understood, however, that the present disclosure is to be considered an exemplification of the principles of the invention and is not intended to limit the spirit and scope of the invention and/or claims of the embodiments illustrated.

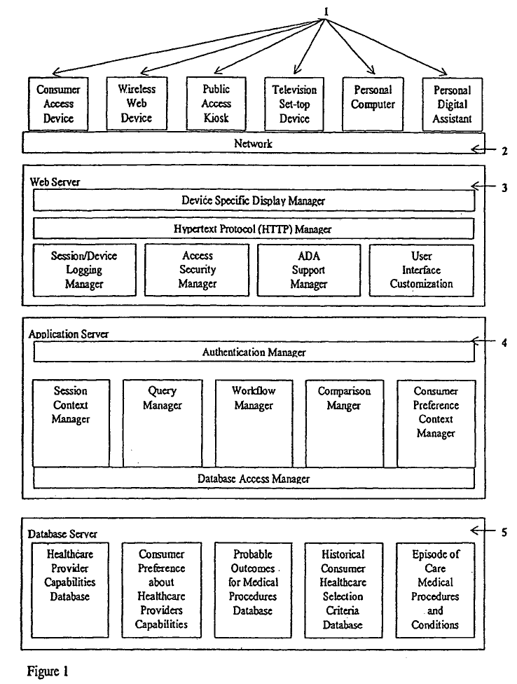

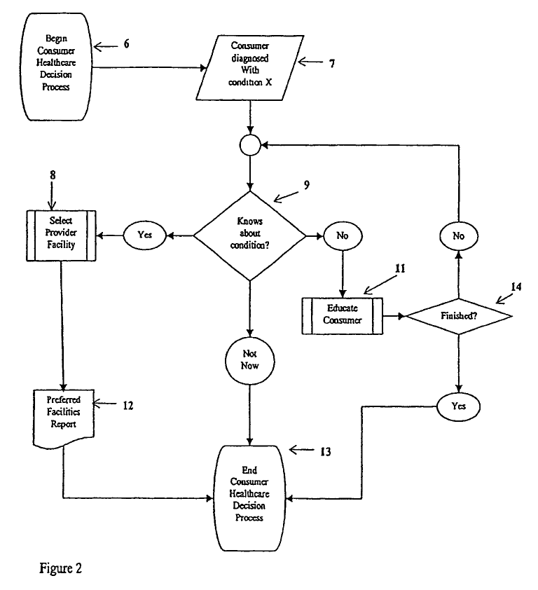

FIG. 1 illustrates a block diagram of the system of the present invention. The system comprises an access device 1 such as a consumer access device, a wireless web device, a public access kiosk, a television set-top device, a personal computer, a personal digital assistant or the like. The access device 1 is used to access a network 2 via any suitable communication link. The network 2 is operatively connected to a web server 3, an application server 4 and a database server 5 in any suitable manner as is know in the art.

The web server 3 comprises a number of devices for managing this server, including a device specific display manager, a hypertext protocol (HTTP) manager, a session/device logging manager, an access security manager, an ADA support manager, and a user interface customization. The application server 4 comprises a number of devices for managing this server, including an authentication manager, a session context manager, a query manager, a workflow manager, a comparison manager, a consumer preference context manager, and a database access manager. The database server 5 comprises a number of devices or databases, for example, a healthcare provider capabilities database, a consumer preference about healthcare providers capabilities database, a probable outcomes for medical procedures database, a historical consumer healthcare selection criteria database, an episode of care medical procedures and conditions database, and any other databases identified herein which are used in the present invention. Together, these servers function, through the use of any and all necessary hardware and software, within the system to provide the above identified objects and advantages of the present invention, as described in more detail below.

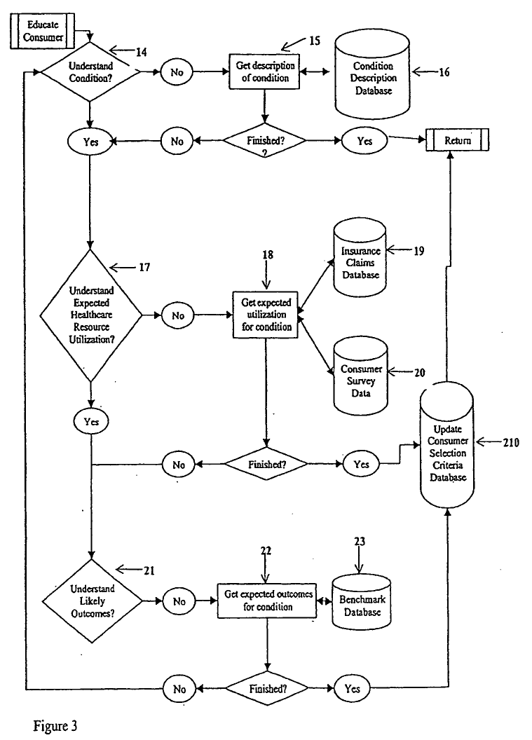

FIG. 2 illustrates a main flowchart of the present invention wherein at step 6, the user begins the consumer healthcare decisionmaking process of the present invention. At step 7, the user identifies or selects the diagnosed condition of specific interest. The user then has the option to learn more about the diagnosed condition, to proceed with the healthcare decisionmaking process, or to end the session. If the user opts to learn more about the condition, the system educates the user at step 11. The user can then continue with the healthcare decisionmaking process or end the session. If the user continues with the healthcare decisionmaking process, the user will proceed to the select provider facility step 8, and then the preferred facilities report step 12, as described in more detail below.

FIG. 3 illustrates a flowchart of the educate consumer step 11 of the present invention. The user is asked whether the user understands the condition at step 14. If not, the system provides the user with a description of the condition at step 15, obtained from a condition description database 16. The user can then return to the healthcare decision making process or continue with the educate consumer step 11. When the user understands the condition, the user is asked whether the user understands the expected healthcare resource utilization at step 17. If not, the system provides the user with the expected utilization for the condition at step 18, obtained from an insurance claims database 19 and a consumer survey data database 20. The user can then return to the healthcare decision making process or continue with the educate consumer step 11. If the user chooses to return to the healthcare decisionmaking process, the consumer selection criteria database is updated at step 210. When the user understands the expected healthcare resource utilization, the user is asked whether the user understands the likely outcomes for the condition at step 21. If not, the system provides the user with the expected outcomes for the condition at step 22, obtained from a benchmark database 23. The user can then return to the healthcare decision making process or return to step 14 to begin the educate consumer process again. If the user chooses to return to the healthcare decisionmaking process, the consumer selection criteria database is updated at step 210.

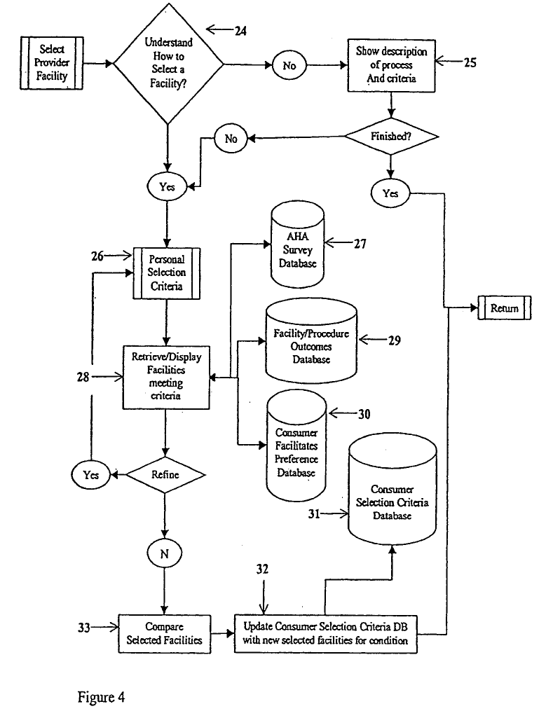

FIG. 4 illustrates a flowchart of the select provider facility step 8 of the present invention. The user is asked whether the user understands how to select a facility for treatment of the specific condition at step 24. If not, the system provides the user with a description of the process and relevant criteria at step 25. The user can then return to the healthcare decision making process or continue with the select provider facility step 8. When the user understands how to select a facility for the condition, the user proceeds to the personal selection criteria step 26 where the user enters personal criteria. The system then retrieves and displays facilities meeting the selected criteria at step 28, obtained from a hospital survey information database 27, a facilities/procedures outcomes database 29, and/or a consumer facilities preference database 30. The user then has the option to refine the selected criteria or to proceed to the compare selected facilities step 33. After comparing the selected facilities at step 33, the system updates the consumer selection criteria database 31 with the new user-selected facilities for the condition, at step 32. The user is then returned to the healthcare decisionmaking process.

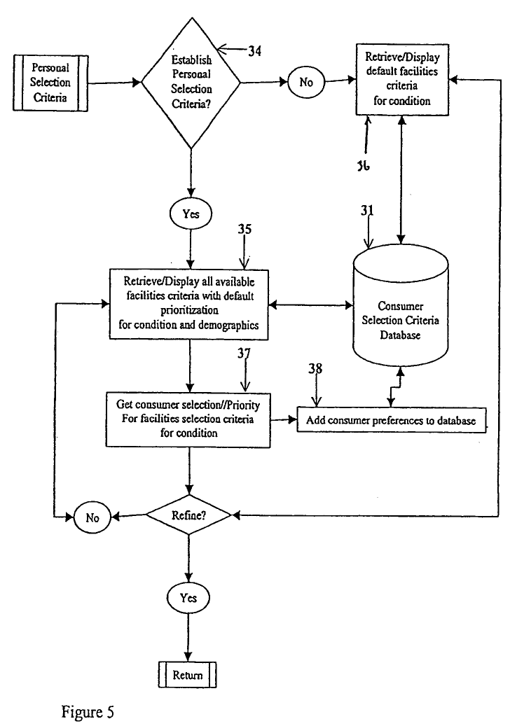

FIG. 5 illustrates a flowchart of the personal selection criteria step 12 of the present invention. The user is asked whether the user desires to establish personal selection criteria at step 34. If not, the system retrieves and displays the default facilities criteria for the condition at step 36. The user then has the option to refine the retrieved criteria, or to return to the healthcare decision making process. When the user desires to establish personal selection criteria, the system retrieves and displays all available facilities criteria with default prioritization for the condition and demographics at step 35, obtained from the consumer selection criteria database 31. The user then selects/prioritizes the retrieved facilities selection criteria for the condition, at step 37. The user's selected consumer preferences are added to the consumer selection criteria database 31, at step 38. The user then has the option to refine the retrieved criteria, or to return to the healthcare decision making process.

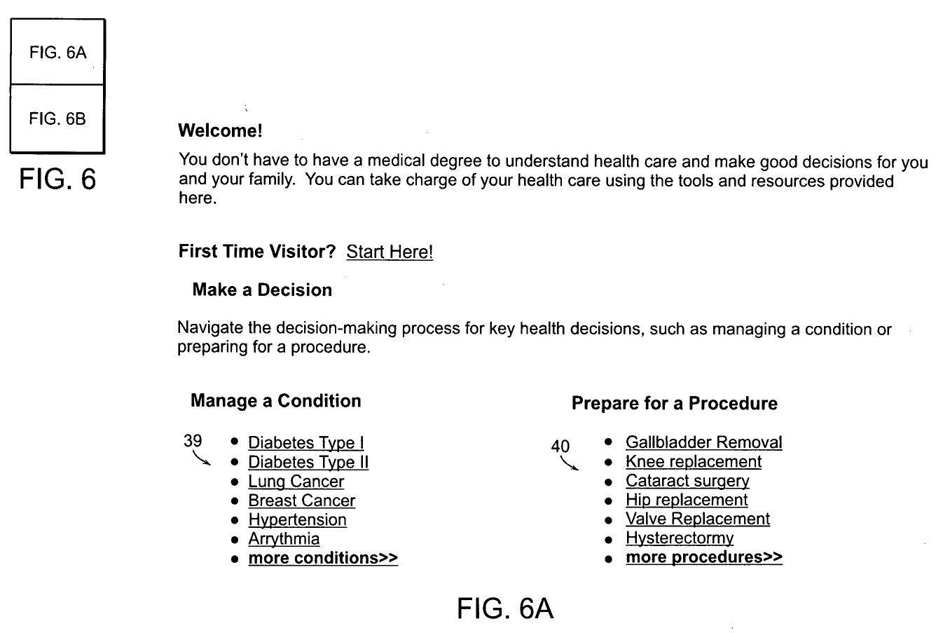

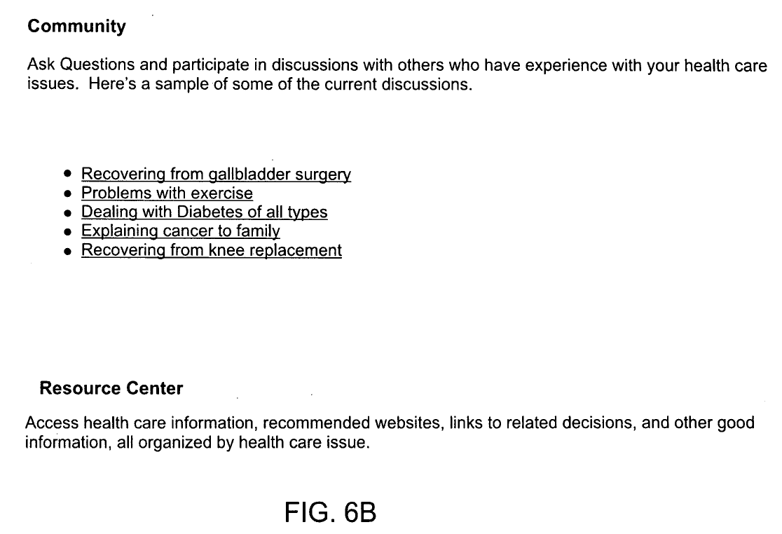

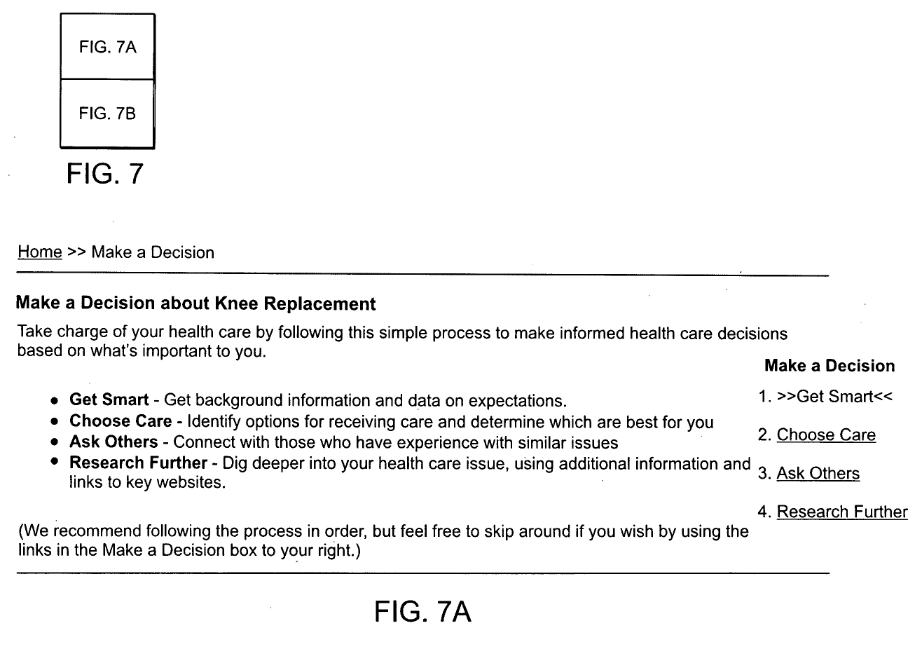

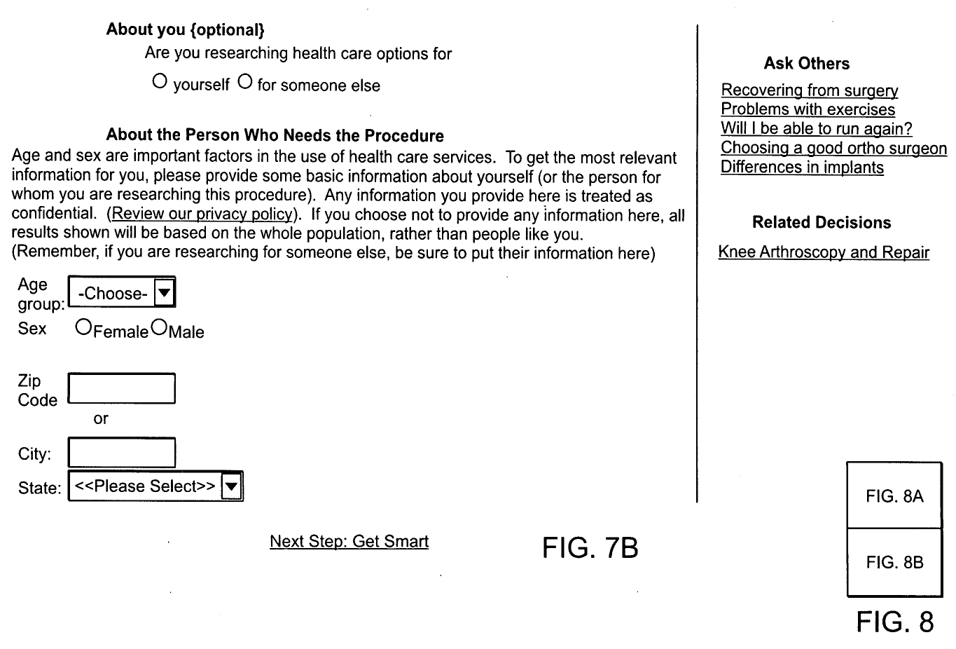

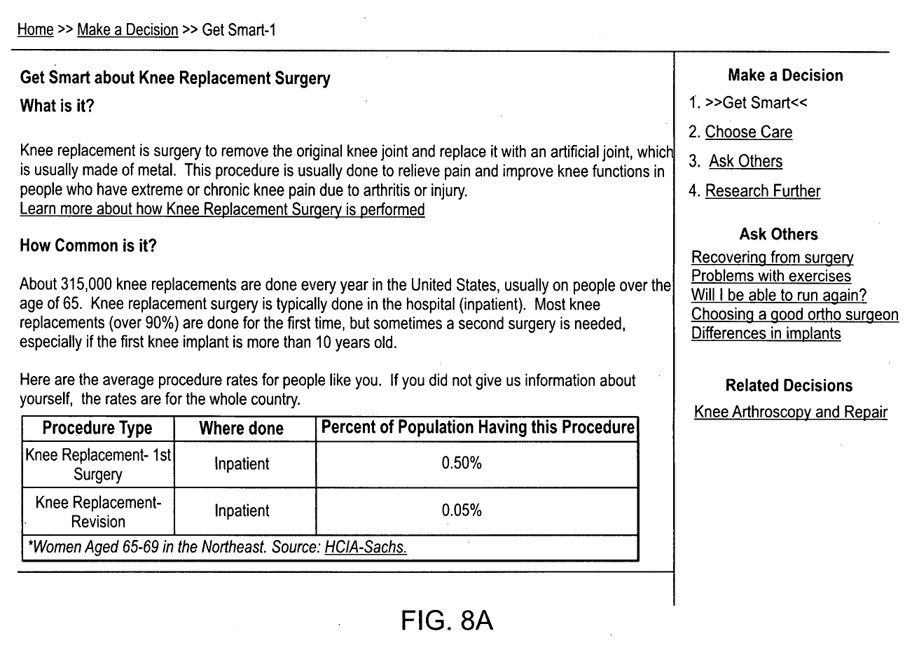

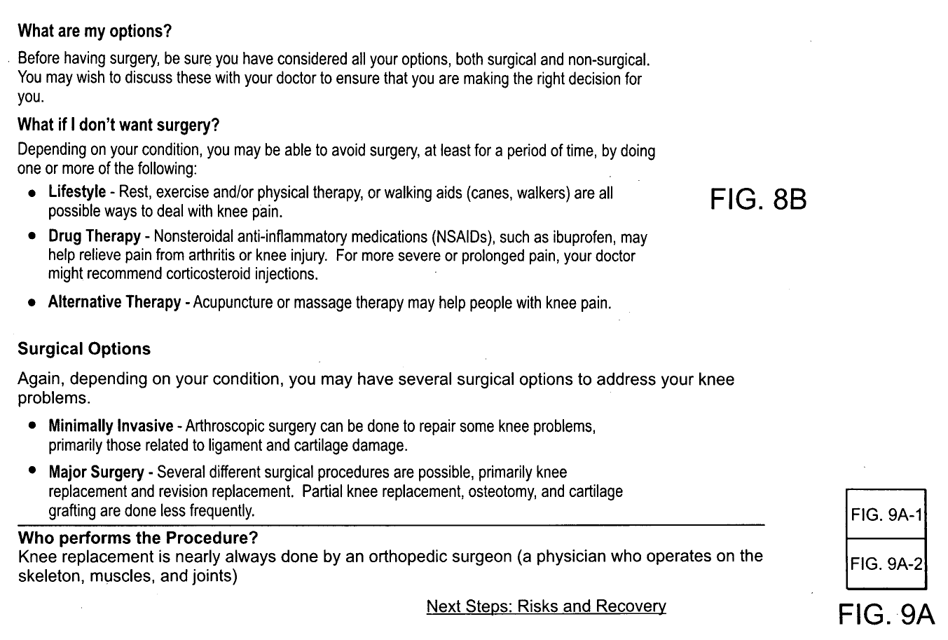

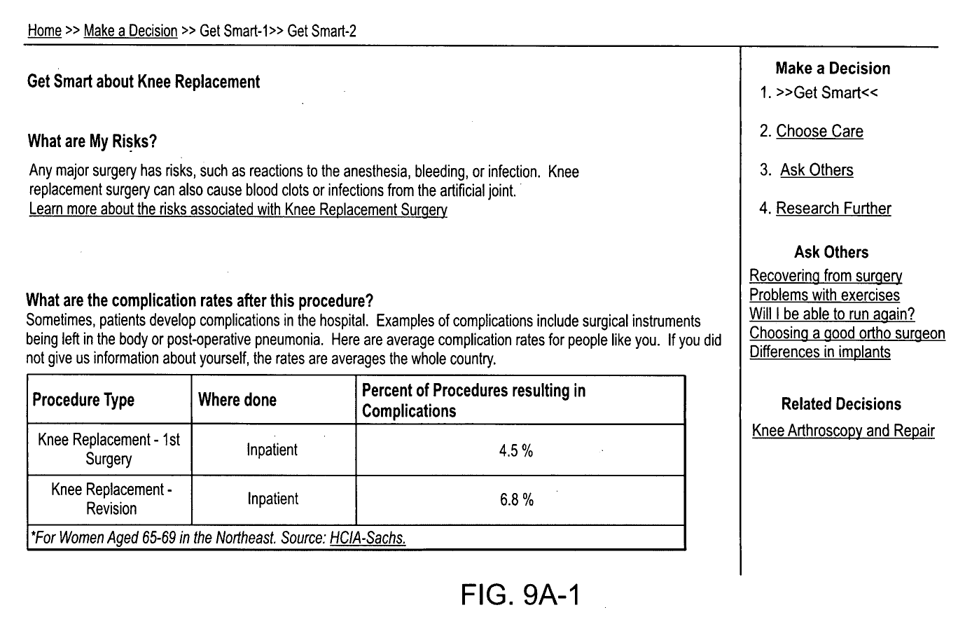

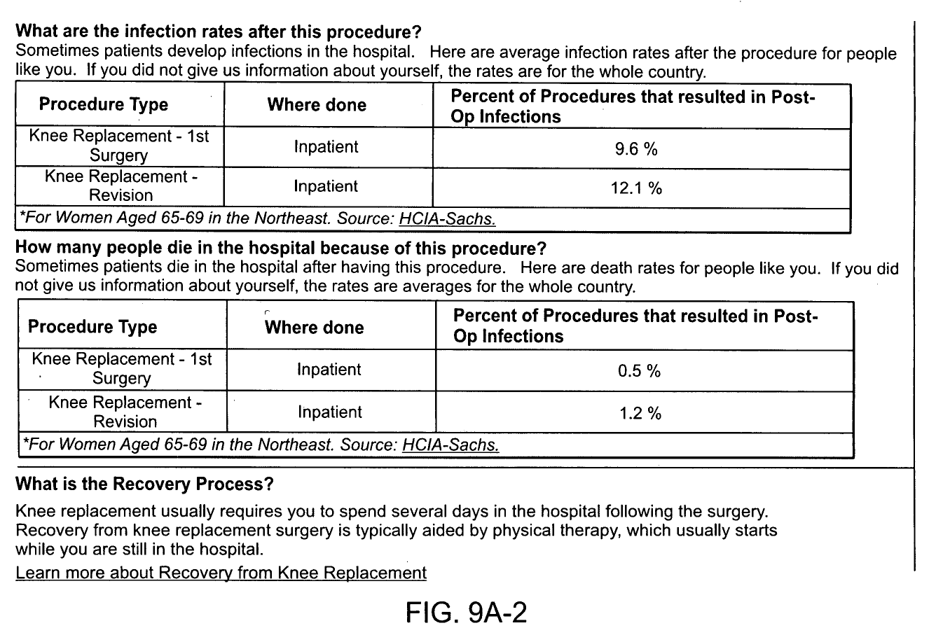

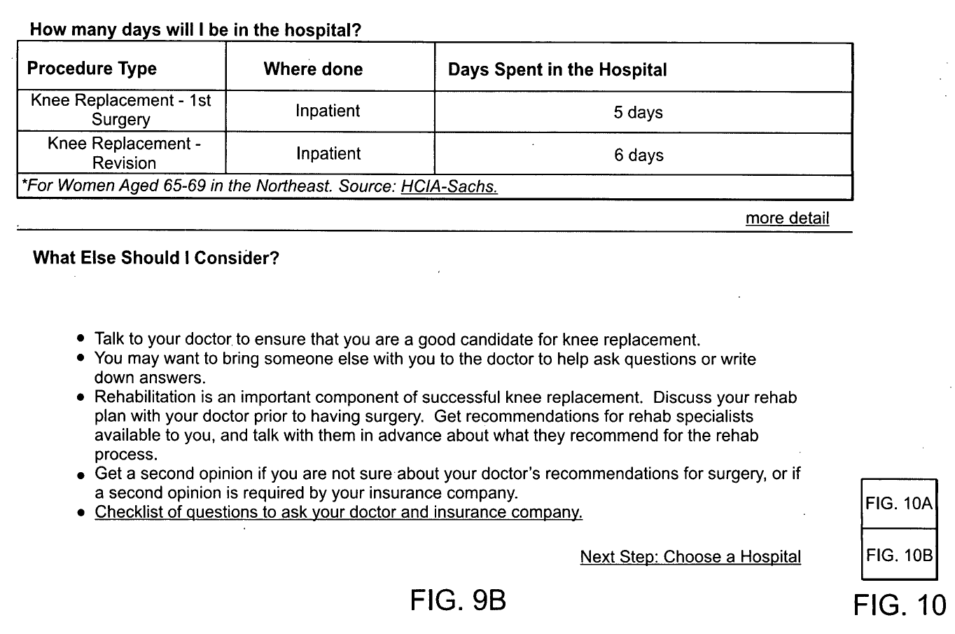

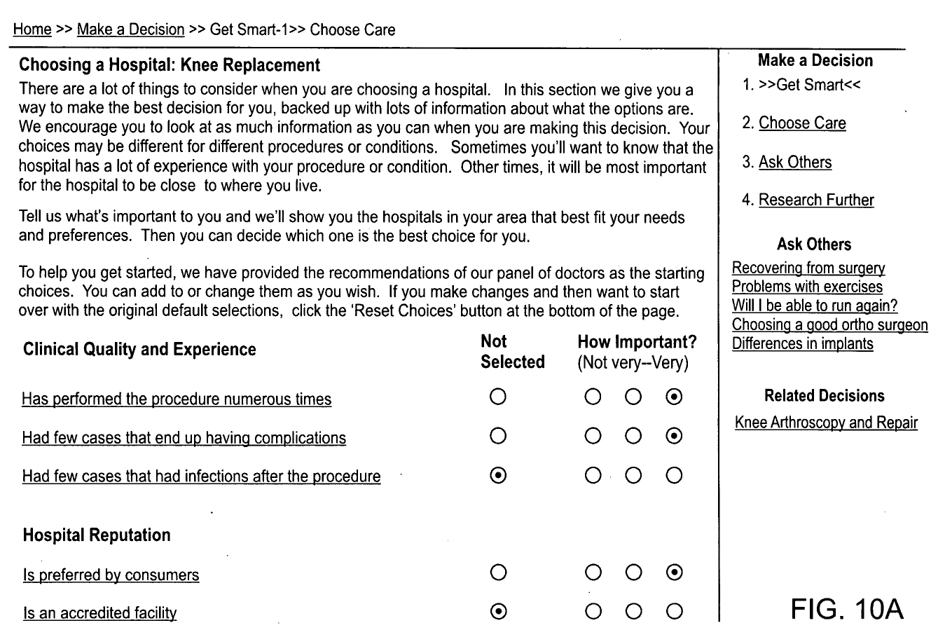

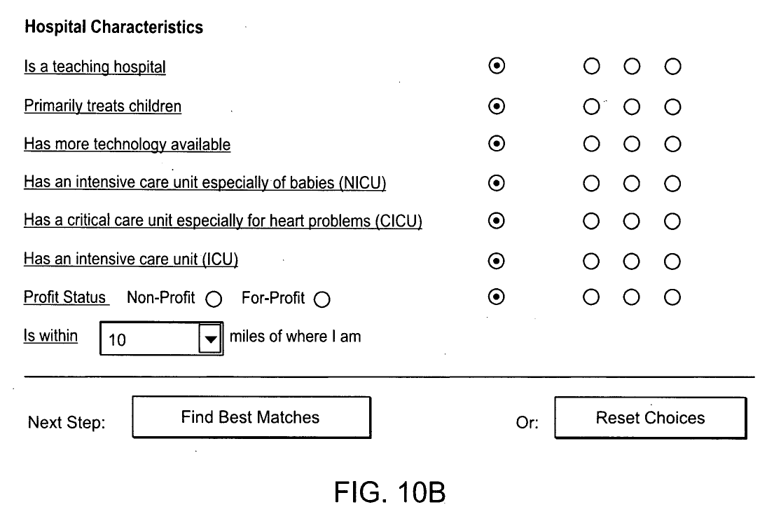

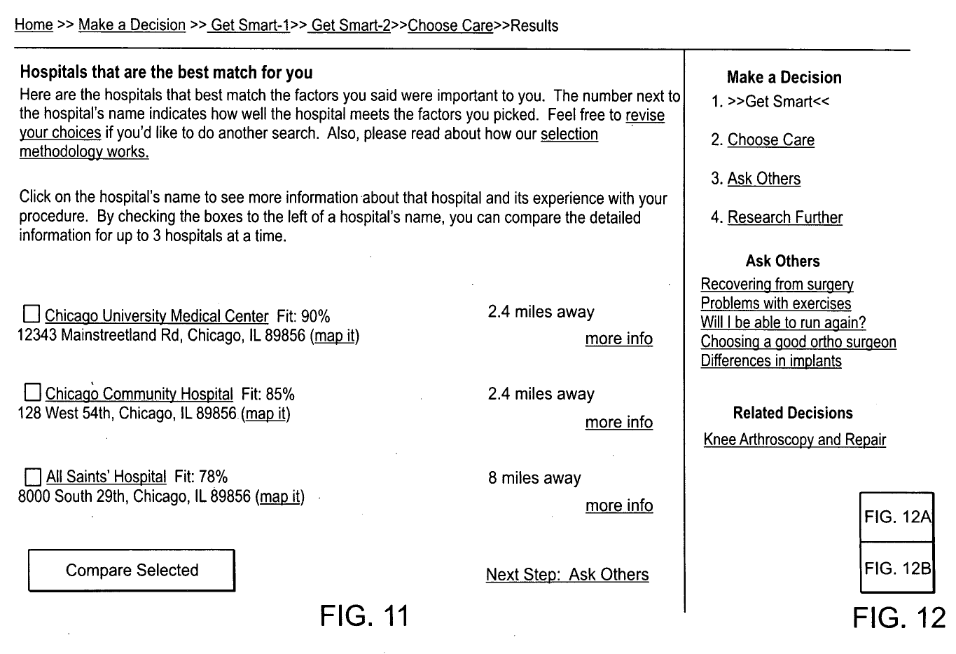

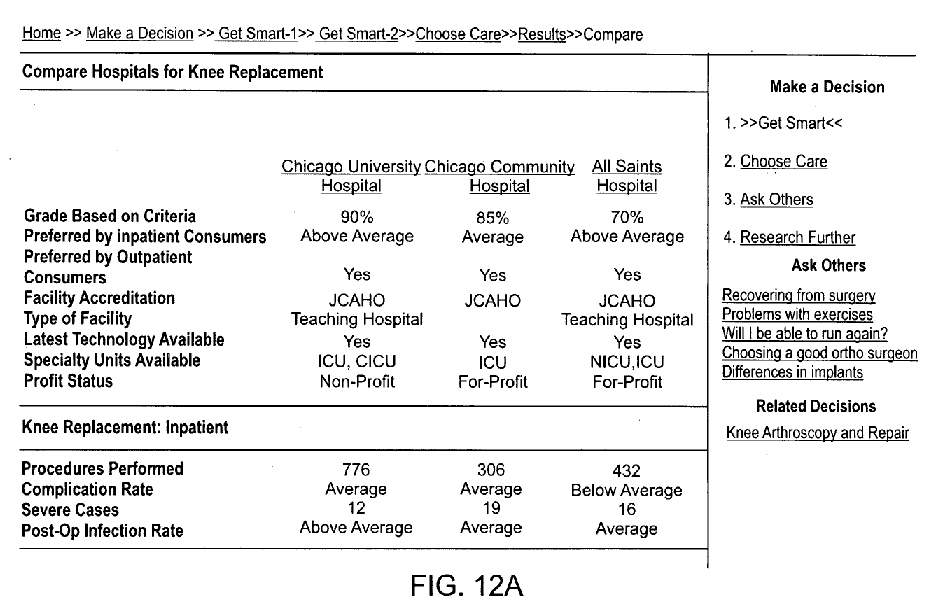

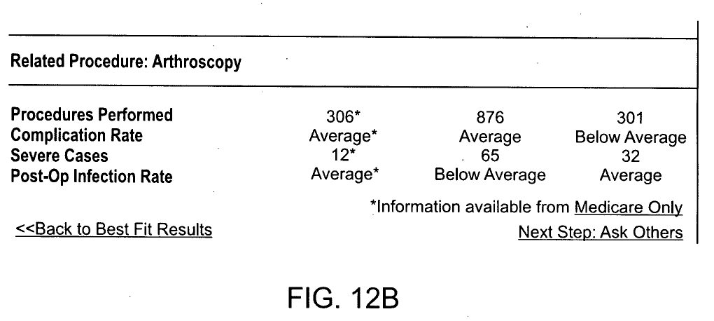

As defined in more detail below, FIGS. 6-12 illustrate the screen displays which a user encounters while progressing through the healthcare decisionmaking process of the present invention. FIG. 6 is an Initial Diagnosis Decision Selection screen. FIG. 7 is a Demographic Collection screen. FIG. 8 is a Consumer Education Characteristics screen. FIG. 9 is a Consumer Education Risk and Recovery screen. FIG. 10 is a Rank Criteria screen. FIG. 11 is a Best Fit Responses to Query screen. Finally, FIG. 12 is a Compare by Personally Important Criteria screen.

Accordingly, in general, the present invention is used as follows. The consumer is asked for personal information, which will serve to refine the query. If the user does not wish to provide this information, then average results for the general population are presented. Although information is captured about the preferences expressed by the consumer, no information is captured which could later relate the preference information back to an individual. Rather, the consumer preference information is anonymously added to the consumer preferences database, thus becoming part of the pool from which consumer criteria and rankings are extracted. The system communicates with a plurality of consumer communication devices 1 through the medium of a standard wired or wireless communication network 2. All display formatting and interface navigation is accomplished through the use of standard HTML (Hypertext Markup Language) and/or XML (Extensible Markup Language), which are embedded in the messages passed between the Web Server 3 and the individual communication device 1.

Messages received from a communication device 1 are received by the Web Server 3, which verifies that the communication device is supported, verifies access rights and initiates logging of accounting information. The information received is then passed to the Workflow Manager component of the Application Server 4, where the query type is authenticated by the Authentication Manager. The Workflow Manager establishes the theme or context for the current session (the condition or procedure being investigated by the consumer) and manages the process from invocation of the decision making framework by the consumer to task completion. The Workflow Manager interacts with other components both within the Application Server and in the Database Server 5 and Web Server 3, to obtain information for presentation to the consumer and ask the consumer for additional information to further refine the decision making process.

The process by which a consumer proceeds under the direction of the Workflow Manager is illustrated in FIG. 2. In beginning the process, illustrated by the screen in FIG. 6, the consumer is asked to select from a list of conditions 39 or procedures 40. After selecting the procedure, the consumer is asked for demographic information at the screen in FIG. 7, which will be used to restrict the search criteria and present results relevant to the user's age, gender, ethnicity and other factors which may be relevant to the particular diagnosis or condition under consideration. The consumer is then presented material which will be relevant in assessing treatment options in the screens of FIGS. 8-10, including prevalence, recovery and risk. The consumer is then given the option of choosing and ranking criteria relevant to the particular condition or procedure under consideration or accepting the options most frequently selected by other consumers with similar demographic profiles, at the screen of FIG. 10. The results are then submitted and result in a set of treatment options which represent the ‘best fit’ with the criteria selected by the consumer, illustrated in the screen of FIG. 11. There results can, in turn, be selected for detailed comparison of alternatives, illustrated in the screen of FIG. 12.

Referring back to FIG. 2, a consumer must first select a condition 39 or procedure 40 for consideration, step 7. This results in a choice, at step 9, by the consumer to either learn more about the item under consideration and its attendant risks, step 11, or proceed immediately to the recommendations for a generic user (Quick Decision) at step 8, the remainder of which process is described with respect to results comparison below.

In FIG. 7, the consumer is asked to supply demographic information relevant to the item under consideration. This information is used to categorize all subsequent preference information expressed by the consumer. If the user does not wish to provide this information, then average results for the general population are presented. Information about the item under consideration is presented to the consumer from the Condition Description Database, step 16 (FIG. 3), with performance, risk, cost and consumer preference information coming from the Insurance Claims, Consumer Survey and Benchmark databases 19, 20, 23, respectively. Presentation of this information is illustrated in the screens of FIG. 8 and FIGS. 9a-b. The consumer is then asked to select criteria and rank order them at the screen of FIG. 10. These criteria are derived from the Consumer Selection Criteria database 31 (FIG. 4). The ranked criteria then formulates matches data from a Hospital Survey Information database 27, a Facilities/Procedures Outcomes database 29, and a Consumer Facilities Preference database 30. The consumer is then presented at the screen of FIG. 11 with a set of treatment options that represent the ‘best fit’ with the criteria selected by the consumer. There results can, in turn, be selected for detailed comparison of alternatives at the screen of FIG. 12. At the end of the process, a Consumer Selection Criteria database 31 is updated with the new set of selected and ranked criteria along with the accompanying demographic information.

The following is a typical usage scenario:

### Assumptions

The user must have access via some client device, which is connected either directly or via a gateway, forwarder, router or proxy to an electronic communications network. This network in turn must be attached to a server device, which embodies the methods and data which constitute the healthcare decisionmaking system. The server subsystem is preferably an Internet Web server with database and application logic resident either on the same physical computing device or co-located on physically adjacent, interconnected computing devices.

The user accesses the functionality made available by the server device through the user interface provided by the client device (a personal computer or network-attached computer with Web-browsing capabilities, digital cellular telephone with integrated Web-browsing capabilities, personal digital assistant with Web-browsing capabilities and with wired or wireless network access or a network device or subsystem providing a protocol translation function between a private or proprietary communications network and the network to which the server device is attached). The remote interface is preferably a Web browser enabled personal computer, network computer, personal digital assistant (PDA), or personal communication system (PCS) cellular telephony device connected to the Web server via the Internet or other network means.

The user interface of the client device must allow the user to read or hear described (in the case of an electronic text-to-speech conversion device), information related to the medical procedure or condition in question. A navigation tool (mouse, cursor movement keys, stylus, gestural or vocalization-based navigation or other) allows the user to select items from a list of choices, indicate preferences from a range (for example: no preference, low importance, moderate importance or high importance), and choose between backward or forward navigation through the workflow. A data entry tool (keyboard, keypad, handwriting recognition, voice recognition or other) allows the user to provide textual information.

The user, or the person on whose behalf the user is accessing the healthcare decisionmaking system, has to have received a medical diagnosis and/or recommendation for treatment (e.g., managing the condition or having surgery to correct a problem).

### Goal

Users understand and determine the best care alternatives based on objective data and personal circumstances and preferences.

### Workflow

The user is presented with a list of medical conditions and procedures (FIG. 6). Selected procedures and conditions are placed on the first screen page. If the user does not find his or her procedure or condition of Interest on the first screen page, the “more procedures” or “more conditions” links may be selected to bring up a full list of available conditions and procedures.

The user selects an item from the list, for example Knee Replacement Surgery. The user is then given an overview of steps for the remainder of the workflow, and is asked to provide some specific demographic information (FIG. 7).

Age Group, Sex and Zip Code allow subsequent information about frequency and cost to be more specific to the individual's circumstance. If either Age or Sex or both are omitted, then consideration for those criteria will he based on national average data.

For procedures, Zip Code also allows the calculation of distances between the user's location and the place of treatment. It is important to note that Zip Code does not necessarily correlate to home or work address. For example, a traveler might enter the Zip Code of their current location because they need immediate treatment.

The user then selects Next Step: Get Smart and is taken to the beginning of the Get Smart section (FIG. 8).

### Get Smart

The goal of this section is to provide the user with objective data and evidence regarding this healthcare event (procedure or condition). Here the user is provided with information which will be helpful in completing the workflow and evaluating his or her alternatives for treatment.

First, a brief explanation or description of the procedure or condition is presented to provide an overview of the procedure or condition and to reassure the user that they are indeed receiving information on the correct topic. A link to more in-depth background information (e.g., Learn more about how a knee replacement is performed) about the condition or procedure is also provided.

In the following paragraphs, the user is presented with an overview of prevalence or incidence rates, options for treatment, and the types of medical specialists typically providing treatment. Using this information, the user is able to develop a broader and more accurate perspective on their diagnosis or the diagnosis of the person on whose behalf they are researching the issue.

The user then selects Next Steps: Risks and Recovery to complete their overview of the condition or procedure. In the Risks and Recovery section (FIG. 9a-b), the user is presented with objective data regarding the frequency of adverse outcomes associated with this type of healthcare event. Next, the user is presented with estimated length of hospitalization (for procedures). Finally, the user is given a list of specific points to consider relative to this healthcare event and a checklist of questions to use in discussions with doctors and insurance companies that are specific to this type of healthcare event.

By selecting Next Step: Choose a Hospital (for procedures), the user is given the opportunity to use the objective data gathered thus far and combine it with personal preferences to identify the best hospital(s) for him or her.

### Choose Care—Choose a Hospital

The goal of this section (FIG. 10) is to allow the user to evaluate which personal preferences may interact with, and in some cases override, other more objective factors. For example, an 84-year-old facing knee replacement surgery might value proximity to spouse and family much higher than number of surgeries performed each year, even though volume is more related to successful outcomes than location.

For each of the criteria displayed, it is possible to rank the criterion as either “Low Importance”, “Moderate Importance”, “High Importance” or “Not Selected.” Ranking a criterion as “Not Selected” means that it will not be considered in the selection process. For each of the criteria, more detailed information (for example, Has performed the procedure many times) is available to assist the user in understanding the significance of that criterion and why the user may wish to include it. Finally, selection of the Find Best Matches button takes the user to a list of facilities which are the best match for this combination of healthcare problem, recommended treatment, location and personal circumstances and preferences.

On the final screen page of the main workflow (FIG. 11), the user is presented with a list of facilities which meet the specified criteria. The presentation includes the name of the facility, its percentage match based upon both objective and personal criteria, address and distance from the facility's location to the center of the user's zip code. Detailed information about the facility may be obtained by following the more info link or clicking on the facility's name, and facilities may be compared by clicking the check box at the head of up to three facility records, as illustrated, and then the clicking the Compare Selected button. This brings up a more detailed comparison of up to three facilities (FIG. 12), as illustrated. However, the comparison of any number of facilities is contemplated.

At any time, the user may restart the entire workflow, or return to a previous page and, for example, change the criteria that are input into the selection process. In addition, the current instantiation of the process also allows the user to participate in online discussions with other users facing similar decisions and link to other sites containing related information.

### Results

After completing the workflow, the user has a greater understanding of the factors related to the healthcare issues in question, and has been able to use objective data and personal circumstances and preferences to examine alternatives for care. By altering personal preferences while the evidence-based data remains constant, the user is able to see how personal preferences may impact choices and also compare how similarly related facilities rank on various dimensions.

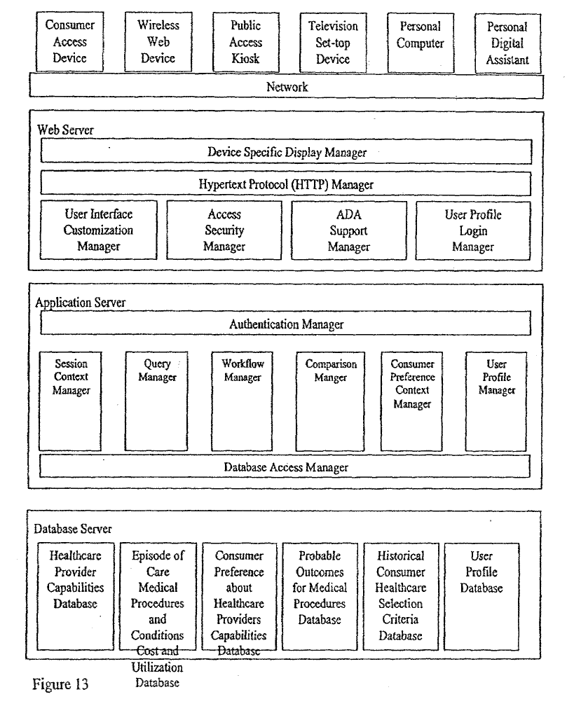

An alternate embodiment of the present invention is illustrated in FIG. 13, and relates to Stored Consumer Profiles. The additional embodiment shown in FIG. 13 allows the consumer to maintain one or more profiles containing demographic information (for example, self, spouse, children, parents) which may be stored and then reused across multiple sessions. These profiles will be particularly useful for consumers who are researching treatment options for chronic conditions like diabetes, end-stage renal disease or chronic obstructive pulmonary disorder and will allow the consumer to shorten the decision making framework by not requiring the reentry of demographic information.

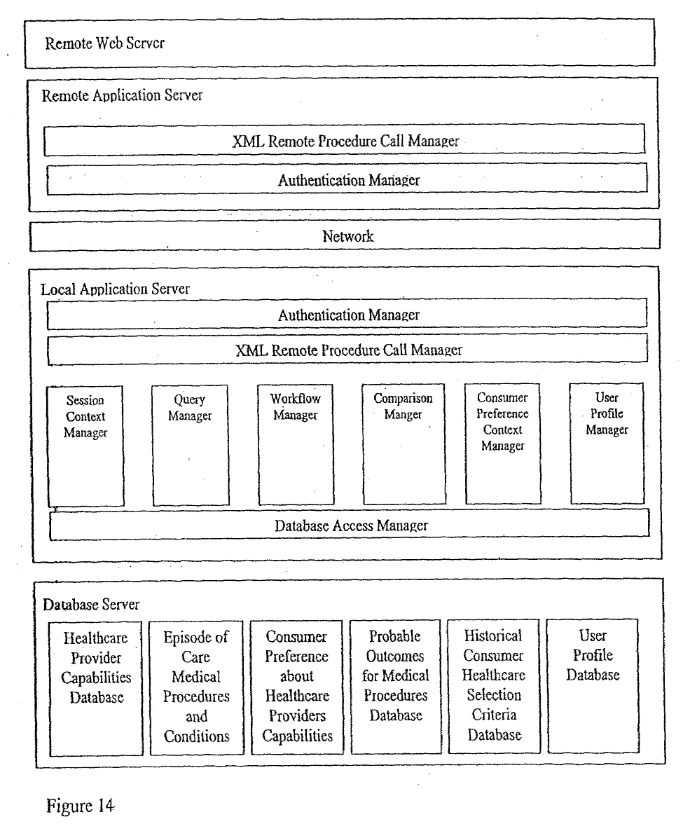

Another alternate embodiment of the present invention is illustrated in FIG. 14, and relates to XML Remote Procedure Call. There are various possibilities for the integration of the information created via the decision making framework with other relevant information sources, for example, employee benefit plans, insurance policies, Medicare benefits, etc. As illustrated in FIG. 14, a further mechanism allows a remote application server to gather information on behalf of the decision making framework, package each of the data elements as a tagged XML field and then submit it directly to the application server on which the decision making framework is running. The decision making framework in turn recognizes that the query has been submitted by a remote application server and responds with a set of XML encoded data elements that can be added to a page served by the remote application server.

From the description above, a number of advantages of this system become evident:
a) It would be advantageous to provide a system that interactively assists a consumer in solving problems such as a determination of the probability of success of a particular medical procedure for a given diagnosis and the risks associated with that procedure for persons who are similar in age, gender, etc.
b) It would be advantageous to provide such a system that would be available to consumers via the Internet and World Wide Web as well as through a plurality of consumer electronic devices.
c) It would be further advantageous to provide such a system that provides a consumer with all of the information necessary to solve the problem. For example, in the healthcare context such information would include definitions of medical conditions and treatments, references to articles from medical journals relating to the diagnosis and treatment and other relevant information such as basic definitions of the diagnosis and treatment.
d) It would be still further advantageous that a highly structured approach should be provided to ensure that the consumer inputs all of the information necessary for the system to present a relevant set of options.
e) The present invention provides a consumer oriented problem solving system having the aforementioned advantages and useful for many different applications.

Accordingly, the reader will see that the structured method for providing consumer healthcare information of this invention can be used to allow an individual consumer to make informed healthcare decisions. Traditionally, information about healthcare has been both legally and practically restricted to healthcare professionals, government oversight agencies and government and private insurance agencies. The present invention provides increased public access to this type of information. As additional sources of healthcare information are made available and integrated into the system, the tool will become even more useful. As consumers are given greater responsibility for healthcare decisions, this tool will allow them to be a more active participant in the healthcare process, reduce the confusion surrounding complex healthcare decisions and provide valuable information that could be further integrated into a total life-planning tool.

Although the description above contains many specificities, these should not be construed as limiting the scope of the invention but as merely providing illustrations of some of the presently preferred embodiments of this invention. For example, a similar technique could be applied in the realm of dentistry, veterinary medicine, etc. Thus the scope of the invention should be determined by the appended claims and their legal equivalents, rather than by the examples given.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A computer-implemented method for providing healthcare information to a healthcare consumer regarding a previously diagnosed health condition, said method comprising:
electronically receiving input from the healthcare consumer via a communication network, said input identifying the previously diagnosed health condition or a procedure for treating the previously diagnosed health condition;
identifying treatment options for said healthcare consumer by searching through one or more electronic databases storing information about a plurality of health care providers, said identified treatment options comprising a listing of healthcare providers for treating the previously diagnosed condition or performing said procedure;
over the communication network, electronically receiving from the healthcare consumer one or more criteria for selecting a healthcare provider;
ranking the healthcare providers in the listing of healthcare providers according to the one or more criteria from the healthcare consumer; and
over the communication network, electronically communicating to the healthcare consumer the identified treatment options and the rankings of the healthcare providers in the list of healthcare providers.

2. The method of claim 1, further comprising correlating the identified treatment options with demographic data.

3-12. (canceled)

13. The method of claim 1, further comprising electronically receiving from the healthcare consumer demographic information about the healthcare consumer, and wherein identifying the treatment options also involves using the demographic information provided by the healthcare consumer to generate the listing of healthcare providers.

14. The method of claim 1, wherein the identified treatment options include one or more treatment procedures and wherein the method further comprises after identifying the treatment options, electronically communicating to the healthcare consumer information about one or more of the identified treatment options.

15. The method of claim 1, further comprising over the communication network, electronically soliciting from the healthcare consumer the one or more criteria for selecting a healthcare provider and wherein receiving from the healthcare consumer one or more criteria for selecting a healthcare provider is in response to soliciting said one or more criteria.

16. The method of claim 15, wherein the identified treatment options include one or more treatment procedures and wherein the method further comprises before soliciting the one or more criteria, electronically communicating to the healthcare consumer information about one or more of the identified treatment options.

17. The method of claim 1, further comprising over the communication network, electronically soliciting said input from the healthcare consumer and wherein receiving said input is in response to soliciting said input.

18. The method of claim 1, wherein electronically communicating the identified treatment options and the rankings of the healthcare providers is for display to the healthcare consumer through a web browser.
